(19) United States
(12) Patent Application Publication
(10) Pub. No.: US 2006/0155975 A1
(43) Pub. Date: Jul. 13, 2006

(54) Method and apparatus for processing conditonal branch instructions

(75) Inventor: Detlef Mueller, Barsbuttel (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/535,697

(22) PCT Filed: Nov. 13, 2003
(86) PCT No.: PCT/IB03/05155

§ 371 Date: May 19, 2005

(30) Foreign Application Priority Data
Nov. 22, 2002 (DE) 102 54 658.4

(51) Int. Cl. G06F 9/44

(52) U.S. Cl. 712/234

(57) ABSTRACT

In the programming of a microcontroller (100) carried out in at least one machine-dependent assembly language in which the assembler commands, with the exception of conditional program branches, are executable essentially independently of data,—in case of a fulfilled branch condition, for example, at least one fulfilled status flag, at least one program counter (10) is loadable with a new address and/or a new value, and—in case of an unfulfilled branch condition, for example, at least one unfulfilled status flag, the instruction is ended. To further develop said programming, together with a method for processing the programming of the microcontroller (100) carried out in at least one machine-dependent assembly language, in such a way that it is invisible from outside whether or not, in the case of a conditional program branch, said branch has actually taken place, it is proposed that, in the case of an unfulfilled branch condition, the program counter (10) is optionally re-loadable with its previous address and/or with its previous value, instead of ending the instruction.

The present invention relates to a microcontroller the programming of which is carried out in at least one machine-dependent assembly language, the assembler commands of which, with the exception of conditional program branches, are executable essentially independently of data,

in case of a fulfilled branch condition, for example, at least one fulfilled status flag, at least one program counter being loadable with a new address and/or a new value, and

in case of an unfulfilled branch condition, for example, at least one unfulfilled status flag, the instruction being ended.

The present invention also relates to a method for processing the programming of a microcontroller of the above-mentioned type carried out in at least one machine-dependent assembly language.

One-chip microcomputers which as a rule are used for controlling devices and in which the C[entral]P[rocessing]U[nit], memory and ports are integrated on one chip are referred to as microcontrollers. The programming of microcontrollers is carried out in machine-dependent assembly language. In the known assembly languages all assembler commands, with the exception of conditional program branches, are carried out independently of data.

A conditional program branch is generally realized as follows: The condition to be checked, as a rule at least one status flag, is tested. If it is found that a branch should take place the program counter is loaded with a new program address (=with a new “value”). If no branch is to take place the instruction is ended, since, of course, the program counter automatically contains the next value, i.e. the next address.

Such a procedure entails that, in the case of conditional program branches, a time difference can occur in the execution of the instruction. The reason for this time difference in the execution of the instruction is that, in the case of a branch, the program counter is additionally set to a new value (to a new program address), whereas in the case of a non-branch the instruction is ended after the condition test.

This means that the execution of commands for conditional branches in microcontroller programs usually has different execution times and therefore also different current values, which are ascertainable by means of dynamic current measurements, depending on whether or not a conditional branch is executed.

A current method of software analysis, which also makes possible misuse by attackers, for example, to ascertain cryptographic keys, consists in identifying conditional program branches by means of a special timing analysis and drawing conclusions regarding the processed data using the identified program flow.

Conclusions regarding the data tested in this instruction can therefore be drawn solely by means of the time sequence of the conditional branch instruction, which, for example in the case of an unauthorized attack on especially security-sensitive sections of a microcontroller program, such as a cryptographic key, is extremely disadvantageous.

Starting from the above-described disadvantages and deficiencies, and taking account of the state of the art which has been sketched, it is the object of the present invention to further develop a microcontroller of the above-mentioned type, together with a method of the above-mentioned type, in such a way that it is invisible from the outside whether or not a branch has actually taken place in the case of a conditional program branch.

This object is achieved by a microcontroller with the features specified in claim 1, and by a method with the features specified in claim 5. Advantageous embodiments and useful further refinements of the present invention are characterized in the respective subsidiary claims.

The teaching of the present invention is therefore to be seen in an operation of microcontrollers, in particular of smartcard controllers, which has been made secure with respect to conditional program branches.

To this end, the internal flow of the instruction processing of the conditional branch is modified according to the invention as follows: in case of a branch the program counter associated with a microcontroller (hereinafter also referred to as the program counter) is loaded with a new value in a manner known as such. Now, however, in the case of a non-branch, instead of ending of the branch instruction, the program counter is also re-loaded, although this time with its own value, in particular with the inclusion of at least one additional logic.

In other words, the procedure according to the present invention means that the result of the test condition is no longer used to end or not to end the internal program processing; rather, the result of the test condition is preferably used to activate at least one multiplexer which, depending on the test result, can supply either a new address to the program counter input or can connect the program counter output for storage to the program counter input.

Consequently, the program counter is in all cases loaded with a new address, i.e. with a new value, regardless of whether a branch should take place or not. This results in identical time flow behavior for both cases.

According to an especially inventive refinement, a further improvement in making conditional branches invisible is obtained if both the testing of the branch condition and the loading of the program counter are carried out with complementary data (=so-called “current blinding” by a complementary program counter), since a person attacking the microcontroller using dynamic current measurements can then no longer distinguish whether or not a branch has been carried out.

In an advantageous embodiment of the present invention the sequence of conditional program branches can be so optimized that the processing of the conditional branch is executed optionally in the above-described manner (program counter is always re-loaded) or in the manner known as such (=a non-branch ends instruction). The control of this option or selection possibility is effected by at least one special bit (=so-called “select bit”).

The above-described option or selection possibility can be advantageously used for the following purposes:

(i) in non-critical parts of the programming of the microcontroller the performance loss (-->longer execution time in the case of a non-branch) caused by loading of the program counter can be suppressed if the select bit option is set to the usual processing;

(ii) if the select bit option is switched on and off in any desired sequence, for example, through a random function or with other suitable bit sequences, all non-branches will be perceived sometimes as a “short” execution time and sometimes as a “long” execution time; an analysis of the data on the basis of the instruction execution times for conditional branches is thereby made significantly more difficult, so that an attacker is deliberately deceived and led astray by the different execution times for identical data in the case of the non-branch of a conditional instruction.

To sum up, considerable advantages of the present invention are to be seen in

the fact that the analysis of data in relation to conditional branches is made considerably more difficult;

the identical execution time for conditional branches through after-loading of the program counter in all cases; and/or

the freely selectable variation whether there is to be a short command execution time or a long command execution time in the case of non-branches. Consequently the present invention, regardless of the structure of the (microcontroller) program, always gives rise to the same dynamic current values and thereby prevents abusive and unauthorized exploration of time-conditioned dynamic current analyses.

The present invention relates finally to an electrical or electronic device controlled by means of at least one microcontroller of the above-described type. As already discussed above, there are various possible ways of embodying and further developing the teaching of the present invention. In this regard reference is made to the appended claims in claim 1 and claim 5.

These and other aspects of the invention are apparent from and will be elucidated with reference to the embodiments described hereinafter.

In the drawing:

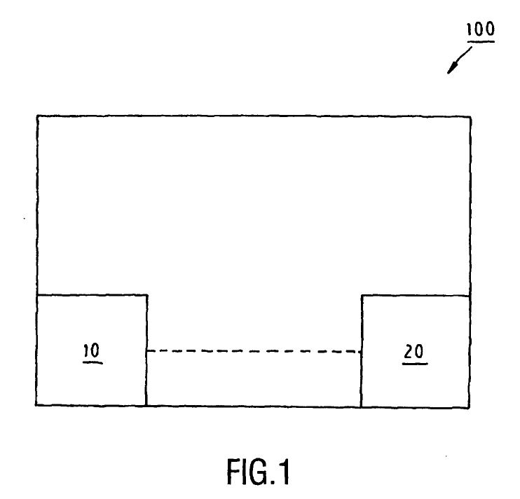

FIG. 1 shows in a schematic representation a block diagram of an embodiment of a microcontroller according to the present invention operated using the method according to the present invention.

FIG. 1 illustrates an embodiment of a microcontroller 100 configured as a smartcard controller, the programming of which is carried out in a machine-dependent assembly language and is processed. In this processing the assembler commands, with the exception of conditional program branches, are executed according to the process independently of data.

In the case of a fulfilled branch condition, for example, a fulfilled status flag, a program counter 10 associated with a microcontroller 100 is loaded with a new address and/or a new value; the special feature of the microcontroller 100 is to be seen in the fact that, with this microcontroller 100, in the case of an unfulfilled branch condition, for example, an unfulfilled status flag, the instruction is not necessarily ended but, in this case of an unfulfilled branch condition, the program counter 10 can optionally be re-loaded with its previous value instead of ending the instruction.

To this end, the microcontroller 100 includes a multiplexer unit 20 which is triggerable by means of the result of the testing of the branch condition,

in the case of a fulfilled branch condition, the new address and/or the new value, and

in the case of an unfulfilled branch condition, the address at the output of the program counter 10 and/or the value at the output of the program counter 10 being supplied to the input of the program counter 10.

Consequently, the actual result of the test condition is no longer used to end or not to end the internal program processing; rather, the result of the test condition is used to activate the multiplexer 20 which, depending on the test result, can either supply a new address (in the case of a fulfilled branch condition) to the input of the program counter 10, or can connect the output of the program counter 10 (in the case of an unfulfilled branch condition) for storage to the input of the program counter 10.

Accordingly, the program counter 10 is in all cases loaded with a new address, i.e. with a new value, regardless of whether or not there is to be a branch. This results in identical time flow behavior in both cases, so that the procedure in the microcontroller 100 according to FIG. 1 always leads to the same dynamic current values, independently of the structure of the (microcontroller) program, consequently preventing an abusive and unauthorized exploration of time-conditioned dynamic current analyses.

A further improvement in the rendering indivisible of conditional branches is obtained in that both the testing of the branch condition and the loading of the program counter 10 are carried out with complementary data (=so-called “current blinding” by a complementary program counter), since a person attacking the microcontroller 100 by means of dynamic current measurements can then no longer distinguish whether or not a branch has taken place.

In the present invention according to FIG. 1 the flow of conditional program branches can be so optimized that the processing of the conditional branch is executed optionally in the above-described manner (program counter 10 is always re-loaded) or in the manner known as such (=non-branch ends instruction). The control of this option or selection possibility is effected by a special bit (=so-called “select bit”).

The above-described option or selection possibility can be used for the following purposes:

(i) in non-critical parts of the programming of the microcontroller 100 the performance loss (-->longer execution time in the case of a non-branch) caused by loading of the program counter 10 can be suppressed if the select bit option is set to the usual processing;

(ii) if the select bit option is switched on and off in any desired sequence, for example, through a random function or with other suitable bit sequences, all non-branches will be perceived sometimes as a “short” execution time and sometimes as a “long” execution time; an analysis of the data on the basis of the instruction execution times for conditional branches is thereby made significantly more difficult, so that an attacker is deliberately deceived and led astray by the different execution times for identical data in the case of the non-branch of a conditional instruction.

### LIST OF REFERENCE NUMERALS

100 Microcontroller, in particular smartcard controller
10 Program counter
20 Multiplex unit or multiplexer

1. A microcontroller the programming of which is carried out in at least one machine-dependent assembly language in which the assembler commands, with the exception of conditional program branches, are executable essentially independently of data,
in case of a fulfilled branch condition, for example, at least one fulfilled status flag, at least one program counter being loadable with a new address and/or a new value, and
in case of an unfulfilled branch condition, for example, at least one unfulfilled status flag, the instruction being ended,
characterized in that in case of an unfulfilled branch condition the program counter, instead of ending the instruction, is optionally re-loadable with its previous address and/or with its previous value.

2. A microcontroller as claimed in claim 1, characterized by at least one multiplex unit triggerable by means of the result of the testing of the branch condition, the input of the program counter
in case of a fulfilled branch condition being loadable with the new address and/or the new value, and
in case of an unfulfilled branch condition being loadable with the address at the output of the program counter and/or with the value at the output of the program counter.

3. A microcontroller as claimed in claim 1, characterized by its configuration as a smartcard controller.

4. An electrical or electronic device controlled by means of at least one microcontroller according to claim 1.

5. A method for processing the programming of a microcontroller carried out in at least one machine-dependent assembly language,
the assembler commands, with the exception of conditional program branches, being executed essentially independently of data,
in case of a fulfilled branch condition, for example, at least one fulfilled status flag, at least one program counter being loaded with a new address and/or with a new value, and
in case of an unfulfilled branch condition, for example, at least one unfulfilled status flag, the instruction being ended,
characterized in that in case of an unfulfilled branch condition the program counter, instead of ending the instruction, is optionally re-loaded with its previous address and/or with its previous value.

6. A method as claimed in claim 5, characterized in that
in case of a fulfilled branch condition the new address and/or the new value, and
in case of an unfulfilled branch condition the address at the output of the program counter and/or the value at the output of the program counter is/are supplied to the input of the program counter.

7. A method as claimed in claim 5, characterized in that the testing of the branch condition and/or the loading of the program counter is/are carried out with complementary data.

8. A method as claimed in claim 5, characterized in that in case of an unfulfilled branch condition the option between ending the instruction and re-loading the program counter with its previous address and/or with its previous value is controlled by at least one special bit (so-called “select bit”).

9. A method as claimed in claim 5, characterized in that, in case of an unfulfilled branch condition, in program parts which are non-critical and/or not security-sensitive the option of ending the instruction is selected in particular by the special bit.

10. A method as claimed in claim 8, characterized in that the special bit option can be switched on and off in any desired sequence, for example, by means of at least one random function and/or by means of at least one suitable bit sequence.
